(19) United States
(12) Patent Application Publication
(10) Pub. No.: US 2021/0237621 A1
(43) Pub. Date: Aug. 5, 2021

(54) SEAT CONTROL SYSTEM

(71) Applicants: Hyundai Motor Company, Seoul (KR); Kia Motors Corporation, Seoul (KR); Dae Won San Up Co., Ltd, Ansan-si (KR); Itopsautomotive Co., Ltd, Suwon-si (KR)

(72) Inventors: Eun Sue KIM, Hwaseong-si (KR); Seung Hyeok CHANG, Suwon-si (KR); Dae Ig JUNG, Suwon-si (KR); Hong Heui LEE, Suwon-si (KR); Han Dong YUK, Seongnam-si (KR); Sang Chul JUNG, Gwangmyeong-si (KR); Sun Ho HUR, Seoul (KR); Dong Kyu LEE, Ansan-si (KR); Han Jin KIM, Wonju-si (KR)

(73) Assignees: Hyundai Motor Company, Seoul (KR); Kia Motors Corporation, Seoul (KR); Dae Won San Up Co., Ltd, Ansan-si (KR); Itopsautomotive Co., Ltd, Suwon-si (KR)

(21) Appl. No.: 17/060,935

(22) Filed: Oct. 1, 2020

(30) Foreign Application Priority Data
Feb. 4, 2020 (KR) 10-2020-0013322

(51) Int. Cl. B60N 2/02; B60N 2/14; B60N 2/00

(52) U.S. Cl. CPC B60N 2/0244; B60N 2/002; B60N 2/14

(57) ABSTRACT

A seat control system facilitating a vehicle may include a plurality of seats that are electrically controlled indoors to avoid interference between the seats or collision between occupants when changing a position of each seat and to adjust a moving speed and a sensitivity of a position-change seat according to the ambient circumstances of the seat so that the collision between occupants or between objects is efficiently prevented, ensuring stability.

### CROSS REFERENCE TO RELATED APPLICATION

The present application claims priority to Korean Patent Application No. 10-2020-0013322, filed Feb. 4, 2020, the entire contents of which is incorporated herein for all purposes by this reference.

### BACKGROUND OF THE INVENTION

### Field of the Invention

The present invention relates to a seat control system facilitating a vehicle including a plurality of seats that are electrically controlled indoors to avoid interference between the seats when moving each seat.

### Description of Related Art

In general, seats are provided inside a vehicle for occupants to sit thereon on each of the front side, where a driver's seat is located, and the rear side thereof. The seats are configured to be movable forwardly or backwardly in a longitudinal direction of the vehicle so that the occupants are in their respective comfortable states according to their physical conditions.

Recently, automatic driving vehicles have been developed, and accordingly, they are configured to automatically adjust a position of a seat to any of various positions. However, when adjusting positions of a plurality of seats in a vehicle, the movement of the seats may cause interference between occupants or collision between an occupant and an object. To solve the present problem, a fail-safe function is added to determine whether a seat is caught based on a change in an amount of current in the motor and to stop the movement of the seat when the seat is caught.

However, the operation of the plurality of seats at the same time causes a seat to be unexpectedly caught, and there is a lack in coping with the present issue. Furthermore, the fail safe function is performed too often or the fail safe function is not performed in an unexpected situation, and as a result, a component may be damaged and an occupant may be injured.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a seat control system facilitating a vehicle including a plurality of seats that are electrically controlled indoors to avoid interference between the seats or collision between occupants when changing a position of each seat and to adjust a moving speed and a sensitivity of a position-change seat according to the ambient circumstances of the seat so that the collision between occupants or between objects is efficiently prevented, ensuring stability.

According to an exemplary embodiment of the present invention, a seat control system includes: a plurality of seats provided indoors, each being configured to be rotatable or movable to change a position of an occupied seat among the plurality of seats; a sensor unit mounted in each of the plurality of seats to detect an occupant on the seat; a driving unit mounted in each of the seats to rotate or move the seat; and a controller connected to the sensor and the driving unit and configured of receiving information from the sensor unit depending on whether or not there is an occupant on each seat and correcting a driving speed of the driving unit depending on whether or not there is an occupant on each seat.

When there is an occupant on a seat to be rotated or moved by reflecting an occupant's intention and there is no occupant on another neighboring seat, the controller may set the driving speed of the driving unit to an initially-set speed.

When there is no occupant on a seat to be rotated or moved by reflecting an occupant's intention and there is no occupant on another neighboring seat, the controller may upwardly correct the driving speed of the driving unit.

When there is an occupant on a seat to be rotated or moved by reflecting an occupant's intention and there is an occupant on another neighboring seat, the controller may downwardly correct the driving speed of the driving unit.

A load reference value for determining whether or not a seat is caught when rotated or moved may be pre-stored in the controller. When an output value for operating the driving unit reaches the load reference value, the controller may be configured to control the driving unit to be forcibly stopped or to be operated in a reverse manner.

When there is an occupant on a seat to be rotated or moved by reflecting an occupant's intention and there is no occupant on another neighboring seat, the controller may maintain the load reference value as an initially-set value.

When there is no occupant on a seat to be rotated or moved by reflecting an occupant's intention and there is no occupant on another neighboring seat, the controller may upwardly correct the load reference value to decrease a sensitivity.

When there is an occupant on a seat to be rotated or moved by reflecting an occupant's intention and there is an occupant on another neighboring seat, the controller may downwardly correct the load reference value to increase a sensitivity.

When a seat is rotated or moved toward another neighboring seat, the controller may downwardly correct the driving speed of the driving unit and the load reference value.

When the seat is rotated or moved in a direction away from the another neighboring seat, the controller may upwardly correct the driving speed of the driving unit and the load reference value.

When the plurality of seats are arranged on one side and on the other side with respect to a front-rear direction of a vehicle, and an occupant's intention to rotate the position of the occupied seat on one side from a forward direction toward a backward direction is reflected, the controller may be configured to control each driving unit such that the seat on one side is moved in the forward direction or in the backward direction and a seat on the other side is moved in the opposite direction of the seat on one side, and then the seat on one side is rotated toward the backward direction thereof.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of a seat control system according to an exemplary embodiment of the present invention.

FIG. 2 is a control table of the seat control system illustrated in FIG. 1.

FIG. 3, FIG. 4, and FIG. 5 are diagrams for explaining the seat control system illustrated in FIG. 1.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, a seat control system according to an exemplary embodiment of the present invention will be described with reference to the accompanying drawings.

A controller according to an exemplary embodiment of the present invention may be implemented through a non-volatile memory configured to store data relating to algorithms configured to control operations of various components of a vehicle or software instructions for reproducing the algorithms, and a processor configured to perform the operations which will be described below using the data stored in the memory. Here, the memory and the processor may be implemented as separate chips. Alternatively, the memory and processor may be implemented as a single integrated chip. The processor may take on the form of one or more processors.

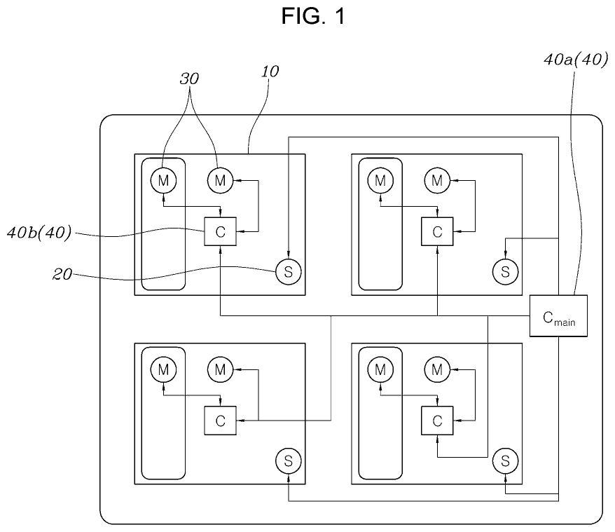

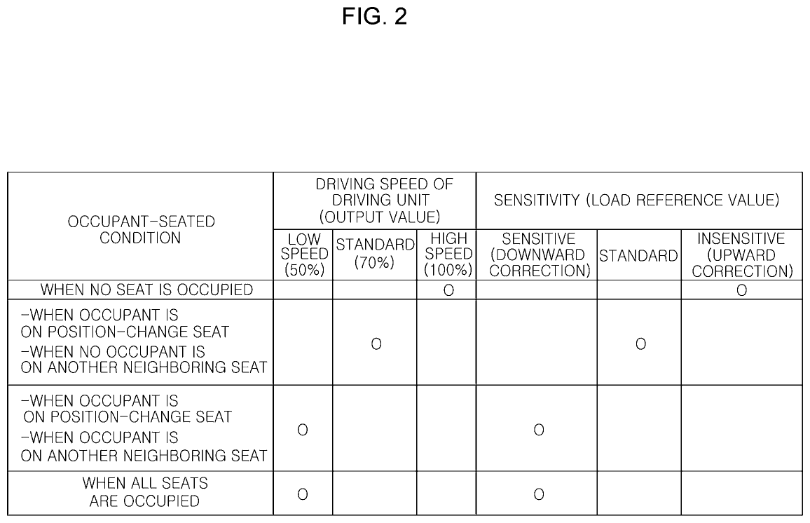

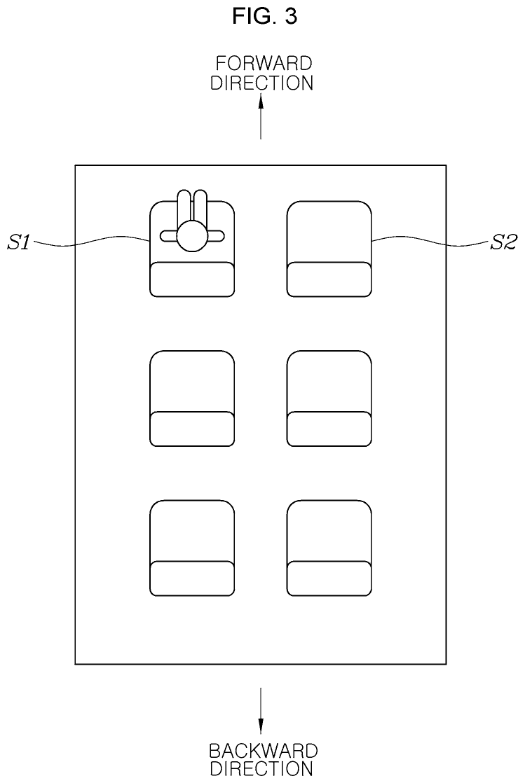

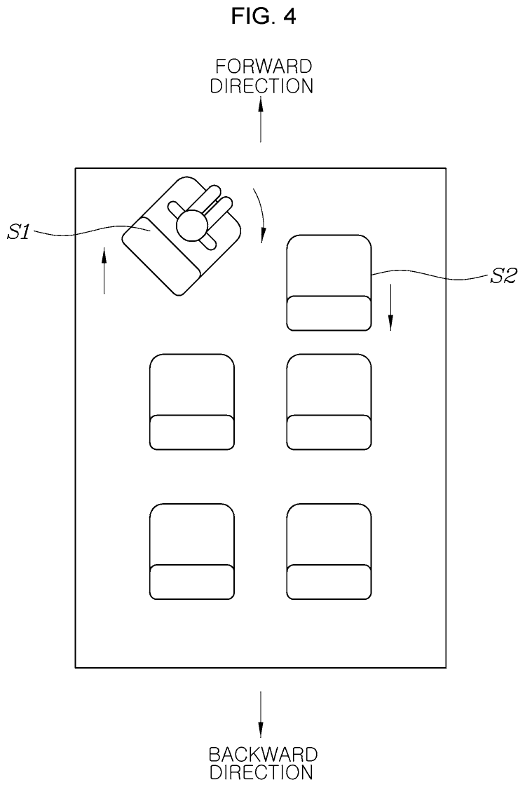

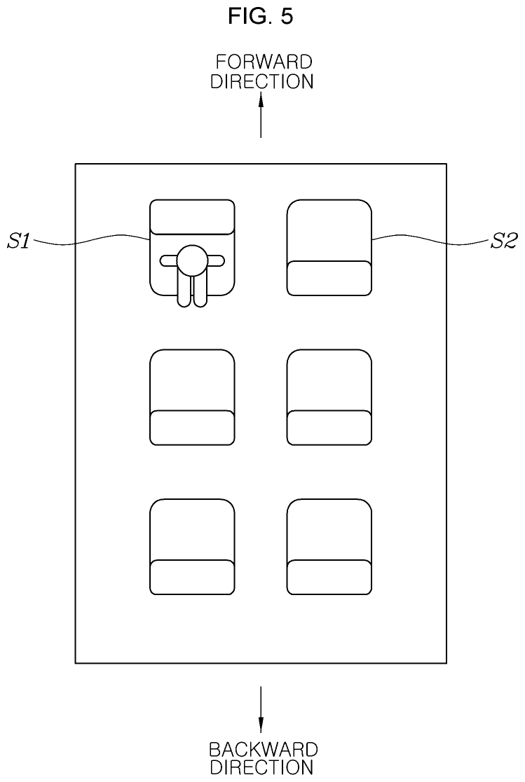

FIG. 1 is a schematic diagram of a seat control system according to an exemplary embodiment of the present invention, FIG. 2 is a control table of the seat control system illustrated in FIG. 1, and FIG. 3, FIG. 4, and FIG. 5 are diagrams for explaining the seat control system illustrated in FIG. 1.

As illustrated in FIG. 1, the seat control system according to an exemplary embodiment of the present invention includes: a plurality of seats 10 provided indoors, each being configured to be rotatable or movable to change a position of an occupied seat among the plurality of seats; a sensor unit 20 mounted in each of the plurality of seats 10 to detect an occupant on the seat 10; a driving unit 30 mounted in each of the seats 10 to rotate or move the seat 10; and a controller 40 receiving information from the sensor unit depending on whether or not there is an occupant on each seat 10 and correcting a driving speed of the driving unit 30 depending on whether or not there is an occupant on each seat 10.

In an exemplary embodiment of the present invention, the plurality of seats 10 provided indoors may be arranged at various positions. To help understand the present invention, in FIG. 3, it is illustrated that the plurality of seats 10 are arranged in two rows, and installation positions of the plurality of seats 10 may vary depending on the design of a vehicle.

The seat 10 may be configured to be rotatable or movable, and the seat 10 may be rotated and moved by the driving unit 30 mounted in the seat 10 to change a portion of an occupied seat. Here, the rotation and movement operations of the seat 10 may be implemented through various methods such as a rail structure and a bracket connection structure, and the driving unit 30 may be configured in a plurality to include a driving unit 30 for the rotation operation and a driving unit 30 for the movement operation. The seat 10 configured for performing the rotation and movement operations is known in various ways, and thus, the detailed description thereof is omitted.

The driving unit 30 transmitting a driving force to rotate and move the seat 10 may include a motor which is operated when a current is applied thereto, and may be operated under the control of the controller 40 when an occupant's intention is reflected. Here, the occupant's intention may be a switch-operational or verbal command. When the occupant's intention is reflected, power is applied to the driving unit 30 so that the seat 10 may be in a rotation or movement operation under the control of the controller 40.

Meanwhile, each seat 10 is provided with the sensor unit 20 for determining whether or not there is an occupant on the seat 10. For the sensor unit 20, a weight sensor or a buckling sensor is applicable, and the sensor unit 20 transmits information depending on whether or not there is an occupant on the seat 10 to the controller 40.

The controller 40 receiving information related to whether or not there is an occupant on each seat 10 through the sensor unit corrects the driving speed of the driving unit 30 depending on whether or not there is an occupant. That is, the controller 40 receives a command signal according to an occupant's intention, checks whether there are occupants on a position-change seat 10 and on another neighboring seat 10 among the plurality of seats 10, and corrects the driving speed of the driving unit 30, to shortening a position change time of the seat 10 and avoid collision, ensuring stability.

Here, the controller 40 includes an auxiliary controller 40b for controlling driving of each seat 10 and a main controller 40a communicating with the vehicle such that the main controller 40a may transmit a command signal and the auxiliary controller 40b may receive the command to control the driving unit 30.

To describe the above-described present invention in more detail, when there is an occupant on a seat 10 to be rotated or moved by reflecting an occupant's intention and there is no occupant on another neighboring seat 10, the controller 40 may set the driving speed of the driving unit 30 to an initially-set speed.

That is, in a situation where there is an occupant on a seat 10 whose position is changed by reflecting an occupant's intention and there is no occupant on another neighboring seat 10, the controller controls the driving unit 30 to be operated at an initially-set driving speed, because there is no risk of collision between occupants although the position of the seat 10 is changed. Here, with respect to the seat 10 on which the occupant sits and of which the position is changed, its driving speed may be increased to rapidly change the position, but the high-speed rotation or movement of the seat 10 causes a decrease in occupant's seating comfort, and as a result, the occupant may feel discomfort. Thus, the position of the seat 10 is changed at the initially-set driving speed.

The driving speed of the driving unit 30 may be adjusted according to an output value that depends on an amount of current applied. In an exemplary embodiment of the present invention, a current of about 2 to 3 A may be applied for the initially-set driving speed.

Meanwhile, when there is no occupant on a seat 10 to be rotated or moved by reflecting an occupant's intention and there is no occupant on another neighboring seat 10, the controller 40 may upwardly correct the driving speed of the driving unit 30.

That is, in a situation where there is an occupant neither on a seat 10 whose position is changed by reflecting an occupant's intention nor on another neighboring seat 10, the risk of collision when changing the position of the seat 10 is completely eliminated. Thus, the controller 40 upwardly corrects the driving speed of the driving unit 30.

A correction value for upwardly correcting the driving speed of the driving unit 30 may be pre-set in the controller 40. When a current according to the initially-set driving speed is 2 to 3 A, the current may be corrected upwardly to about 5 A so that the driving speed is increased. Accordingly, with respect to the seat 10 whose position is changed by reflecting an occupant's intention, the position of the seat 10 is changed at an upwardly corrected driving speed, so that the seat 10 may be rapidly moved to a predetermined position.

Meanwhile, when there is an occupant on a seat 10 to be rotated or moved by reflecting an occupant's intention and there is an occupant on another neighboring seat 10, the controller 40 may downwardly correct the driving speed of the driving unit 30.

That is, in a situation where there are occupants both on a seat 10 whose position is changed by reflecting an occupant's intention and on another neighboring seat 10, the controller 40 downwardly corrects the driving speed of the driving unit 30, because there is a high risk of collision between the occupants when changing the position of the seat 10.

A correction value for downwardly correcting the driving speed of the driving unit 30 may be pre-stored in the controller 40. When a current according to the initially-set driving speed is 2 to 3 A, the current may be corrected downwardly to less than 2 A so that the driving speed is decreased.

Accordingly, with respect to the seat 10 whose position is changed by reflecting an occupant's intention, the position of the seat 10 is changed at a downwardly corrected driving speed, securing a time to cope with a collision situation between the occupants or between objects, and reducing a shock resulting from the collision.

Meanwhile, a load reference value for determining whether or not the seat 10 is caught when rotated or moved is pre-stored in the controller 40. When the output value according to the operation of the driving unit 30 reaches the load reference value, the controller 40 may control the driving unit 30 to be forcibly stopped or to be operated in a reverse manner.

Here, the load reference value, which is for determining whether or not the seat 10 is caught when rotated or moved, is a reference value for detecting that the seat 10 is caught or stuck using an increase in the output value that depends on the amount of current applied for operating the driving unit 30. The load reference value may be pre-stored in the controller 40. When the output value of the driving unit 30 reaches the load reference value, this may be recognized by the controller 40 as an occurrence of a situation where the seat 10 is stuck or caught.

That is, when the driving unit 30 is operated to change the position of the seat 10, if the seat 10 is caught or stuck, the output value of the driving unit 30 is increased to escape the situation. When the increased output value of the driving unit 30 reaches the load reference value, the controller 40 determines that the seat 10 is caught or stuck, and controls the driving unit 30 to be forcibly stopped or to be operated in a reverse manner.

As described above, the seat 10 is stopped or operated in a reverse manner in a caught or stuck situation to escape the caught or stuck situation, minimizing or avoiding additional problems caused by collision, and preventing an injury of an occupant or a damage to a component.

When there is an occupant on a seat 10 to be rotated or moved by reflecting an occupant's intention and there is no occupant on another neighboring seat 10, the controller 40 may maintain the load reference value as an initially-set value.

In a situation where there is an occupant on a seat 10 whose position is changed by reflecting an occupant's intention and there is no occupant on another neighboring seat 10 as described above, the controller 40 maintains the load reference value as the initially-set value, because there is no risk of collision between occupants although the position of the seat 10 is changed.

Here, the controller 40 may decrease the load reference value to improve a sensitivity, but a collision situation may be sensed too sensitively and frequently when the position of the seat 10 is changed, and accordingly, the movement of the seat 10 may be unexpectedly stopped, and an occupant may feel irritated. Furthermore, when the controller 40 increases the load reference value to reduce a sensitivity, a sudden collision situation may be sensed too insensitively, resulting in an injury of an occupant or a damage to a neighboring component.

Accordingly, in a situation where there is an occupant on a seat 10 to be rotated or moved by reflecting an occupant's intention and there is no occupant on another neighboring seat 10, the controller 40 maintains the load reference value as an initially-set value.

Meanwhile, when there is no occupant on a seat 10 to be rotated or moved by reflecting an occupant's intention and there is no occupant on another neighboring seat 10, the controller 40 may upwardly correct the load reference value to reduce a sensitivity.

Here, the load reference value may be a current value which is previously derived to detect a caught or stuck situation based on an amount of current applied for operating the driving unit 30. When the load reference value is upwardly corrected, a reference current value is set to be increased, facilitating the output value of the driving unit 30, which increases when the seat 10 is caught or stuck, to delay reaching the load reference value. Accordingly, the sensitivity of the controller 40 to a situation where the seat 10 is caught or stuck is reduced.

Based thereon, in a situation where there is an occupant neither on a seat 10 whose position is changed by reflecting an occupant's intention nor on another neighboring seat 10, the controller 40 upwardly corrects the load reference value to reduce a sensitivity because the risk of collision when changing the position of the seat 10 is eliminated. As a result, in the situation where there is no risk of collision when changing the position of the seat 10, it is possible to prevent an unnecessary stop of the seat 10 caused when a collision situation is sensed sensitively.

Meanwhile, when there is an occupant on a seat 10 to be rotated or moved by reflecting an occupant's intention and there is an occupant on another neighboring seat 10, the controller 40 may downwardly correct the load reference value to increase a sensitivity.

That is, in a situation where there are occupants both on a seat 10 whose position is changed by reflecting an occupant's intention and on another neighboring seat 10, the controller 40 downwardly corrects the load reference value to increase a sensitivity because there is a high risk of collision between the occupants when changing the position of the seat 10.

In a situation where there are occupants both on a position-change seat 10 and on another neighboring seat 10 and accordingly there is a high risk of collision, the controller sensitively detects a collision situation when changing the position of the seat 10, preventing an injury due to collision between the occupants or a damage due to collision of a component which is caused when changing the position of the seat 10.

As described above, to control the plurality of seats 10 and adjust sensitivities thereof in an exemplary embodiment of the present invention, the driving speed of the driving unit 30 and the sensitivity may be adjusted by the controller 40 according to the occupant's seat-occupied situation as illustrated in the table of FIG. 2.

Meanwhile, when a seat 10 is rotated or moved toward another neighboring seat 10, the controller 40 may downwardly correct the driving speed of the driving unit 30 and the load reference value.

That is, when a seat 10 whose position is changed by reflecting an occupant's intention is rotated or moved toward another neighboring seat 10, an occupant on the position-change seat 10 may collide with an occupant or an object on another neighboring seat 10.

Accordingly, the controller 40 may downwardly correct the driving speed of the driving unit 30 to decrease a position-changed speed of the rotated or moved seat 10, reducing a shock resulting from a collision situation and coping with the dangerous situation. Furthermore, the controller 40 may downwardly correct the load reference value to increase a sensitivity, sensitively sensing a collision situation when the position of the seat 10 is changed and preventing an injury due to collision between occupants or a damage due to collision of a component.

Thereafter, when the seat 10 is rotated or moved in a direction away from another neighboring seat 10, the controller 40 may upwardly correct the driving speed of the driving unit 30 and the load reference value.

That is, when a position-change seat 10 is away from another neighboring seat 10, the risk of collision with an occupant or an object is reduced. Accordingly, the controller 40 upwardly corrects the driving speed of the driving unit 30 to increase a position-changed speed of the seat 10, so that the seat 10 may be moved rapidly to a set position. Furthermore, the controller 40 upwardly corrects the load reference value to decrease a sensitivity, preventing an unnecessary stop of the seat 10 which is caused by sensitively sensing a collision situation when changing the position of the seat 10.

As described above, the present invention deeply considers interference between a seat 10 to be rotated or moved by reflecting an occupant's intention and another neighboring seat 10. That is, the controller 40 corrects the driving speed of the driving unit 30 and the stored load reference value in consideration of whether or not there is an occupant on a seat and a rotation or movement direction of the seat 10, ensuring stability and at the same time efficiently preventing the seat 10 from being caught based on its flexible handling.

Meanwhile, when the plurality of seats 10 are mounted on one side and on the other side with respect to a front-rear direction of the vehicle, and an occupant's intention to rotate a position of an occupied seat S1 on one side from a forward direction toward a backward direction is reflected, the controller 40 may control each driving unit 30 such that the seat S1 on one side is moved in the forward direction or in the backward direction and a seat S2 on the other side is moved in the opposite direction of the seat S1 on one side, and then the seat S1 on one side is rotated toward the backward direction thereof.

That is, the positions of the plurality of seats 10 may be changed, when rotated or moved, to minimize interference with each other. In an exemplary embodiment of the present invention, as illustrated in FIG. 3, in a vehicle where a plurality of seats 10 are arranged on one side and on the other side in a front-rear direction of the vehicle, when a seat S1 on one side is rotated, an occupant on the seat S1 on one side may interfere with a seat S2 on the other side if the seat S1 on one side is rotated in a simple way.

Thus, as illustrated in FIG. 3, the controller 40 moves the seat S1 on one side in a forward direction or in a backward direction and moves the seat S2 on the other side in the opposite direction of the seat S1 on one side to secure a distance between the seat S1 on one side and the seat S2 on the other side thereof. Once the distance between the seat S1 on one side and the seat S2 on the other side is secured, the controller 40 controls the driving unit 30 to rotate the seat S1 on one side, so that the occupant on the seat S1 on one side may avoid interference with the seat S2 on the other side for a stable rotating operation. When the rotation of the seat S1 on one side is completed, the controller 40 may move the seat S1 on one side to a correct position to complete the rotating operation of the seat S1 on one side thereof.

Furthermore, when the seat S1 on one side is rotated or moved, the rotation or movement operation of the seat S1 on one side may be smoothly performed through an operation for securing a separation distance with respect to a seat 10 provided in front of or behind the seat S1 on one side thereof.

This is identically applicable when the positions of the other seats 10 are changed. When the seat 10 is rotated or moved, the seat 10 may avoid interference with the other seats 10, preventing an injury of an occupant or a damage to a component.

The seat control system having the above-described structure enables a vehicle including a plurality of seats that are electrically controlled indoors to avoid interference between the seats or collision between occupants when changing a position of each seat and to adjust a moving speed and a sensitivity of a position-change seat according to the ambient circumstances of the seat so that collision between occupants or between objects is efficiently prevented, ensuring stability.

In addition, the term “controller” refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The controller according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors.

The controller may be at least one microprocessor operated by a predetermined program which may include a series of commands for carrying out a method in accordance with various exemplary embodiments of the present invention.

The aforementioned invention can also be embodied as computer readable codes on a computer readable recording medium. The computer readable recording medium is any data storage device that can store data which can be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc. and implementation as carrier waves (e.g., transmission over the Internet).

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

In addition, the term of “fixedly connected” signifies that fixedly connected members always rotate at a same speed. Furthermore, the term of “selectively connectable” signifies “selectively connectable members rotate separately when the selectively connectable members are not engaged to each other, rotate at a same speed when the selectively connectable members are engaged to each other, and are stationary when at least one of the selectively connectable members is a stationary member and remaining selectively connectable members are engaged to the stationary member”.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A seat control system comprising:
a plurality of seats provided indoors, each being rotatable or movable to change a position of an occupied seat among the plurality of seats;
a sensor mounted in each of the plurality of seats to detect an occupant on the occupied seat;
a driving unit mounted in each of the plurality of seats to rotate or move the occupied seat; and
a controller connected to the sensor and the driving unit and configured of receiving information from the sensor depending on whether there is an occupant on each seat of the plurality of seats and of correcting a driving speed of the driving unit depending on whether there is the occupant on each seat.

2. The seat control system of claim 1, wherein upon determining that there is an occupant on a seat among the plurality of seats to be rotated or moved by reflecting an occupant's intention and there is no occupant on another neighboring seat among the plurality of seats, the controller is configured to set the driving speed of the driving unit to a predetermined speed.

3. The seat control system of claim 1, wherein upon determining that there is no occupant on a seat among the plurality of seats to be rotated or moved by reflecting an occupant's intention and there is no occupant on another neighboring seat among the plurality of seats, the controller is configured to upwardly correct the driving speed of the driving unit.

4. The seat control system of claim 1, wherein upon determining that there is an occupant on a seat among the plurality of seats to be rotated or moved by reflecting an occupant's intention and there is an occupant on another neighboring seat among the plurality of seats, the controller is configured to downwardly correct the driving speed of the driving unit.

5. The seat control system of claim 1, wherein a load reference value for determining whether a seat among the plurality of seats is caught upon determining that the seat is rotated or moved is pre-stored in the controller, and upon determining that an output value for operating the driving unit reaches the load reference value, the controller is configured to control the driving unit to be stopped or to be operated reversely.

6. The seat control system of claim 5, wherein upon determining that there is an occupant on a seat among the plurality of seats to be rotated or moved by reflecting an occupant's intention and there is no occupant on another neighboring seat among the plurality of seats, the controller is configured to maintain the load reference value as a predetermined value.

7. The seat control system of claim 5, wherein upon determining that there is no occupant on a seat among the plurality of seats to be rotated or moved by reflecting an occupant's intention and there is no occupant on another neighboring seat among the plurality of seats, the controller is configured to upwardly correct the load reference value.

8. The seat control system of claim 5, wherein upon determining that there is an occupant on a seat among the plurality of seats to be rotated or moved by reflecting an occupant's intention and there is an occupant on another neighboring seat among the plurality of seats, the controller is configured to downwardly correct the load reference value.

9. The seat control system of claim 5, wherein upon determining that a seat among the plurality of seats is rotated or moved toward another neighboring seat among the plurality of seats, the controller is configured to downwardly correct the driving speed of the driving unit and the load reference value.

10. The seat control system of claim 9, wherein upon determining that the seat is rotated or moved in a direction away from the another neighboring seat, the controller is configured to upwardly correct the driving speed of the driving unit and the load reference value.

11. The seat control system of claim 1, wherein upon determining that the plurality of seats are mounted on one side and on another side with respect to a front and rear direction of a vehicle, and an occupant's intention to rotate a position of the occupied seat on one side from a forward direction toward a backward direction is reflected, the controller is configured to control each driving unit so that the seat on one side is moved in the forward direction or in the backward direction and a seat on another side is moved in an opposite direction of the seat on the one side, and then the seat on the one side is rotated toward the backward direction thereof.

12. A method of controlling a seat control system having a plurality of seats, the method comprising:
receiving, by a controller, information from a sensor connected to the controller, depending on whether there is an occupant on each seat of the plurality of seats, and
correcting a driving speed of the driving unit depending on whether there is the occupant on each seat,
wherein the plurality of seats is provided indoors, each being rotatable or movable to change a position of an occupied seat among the plurality of seats,
wherein a sensor is mounted in each of the plurality of seats to detect an occupant on the occupied seat, and
wherein a driving unit is mounted in each of the plurality of seats to rotate or move the occupied seat, according to a signal of the controller, and
wherein the controller includes:
a processor; and
a non-transitory storage medium on which a program for performing the method is recorded and executed by the processor.

13. The method of claim 12, wherein upon determining that there is an occupant on a seat among the plurality of seats to be rotated or moved by reflecting an occupant's intention and there is no occupant on another neighboring seat, setting, by the controller, the driving speed of the driving unit to a predetermined speed.

14. The method of claim 12, wherein upon determining that there is no occupant on a seat among the plurality of seats to be rotated or moved by reflecting an occupant's intention and there is no occupant on another neighboring seat among the plurality of seats, upwardly correcting, by the controller, the driving speed of the driving unit.

15. The method of claim 12, wherein upon determining that there is an occupant on a seat among the plurality of seats to be rotated or moved by reflecting an occupant's intention and there is an occupant on another neighboring seat among the plurality of seats, downwardly correcting, by the controller, the driving speed of the driving unit.

16. The method of claim 12, wherein a load reference value for determining whether a seat among the plurality of seats is caught upon determining that the seat is rotated or moved is pre-stored in the controller, and upon determining that an output value for operating the driving unit reaches the load reference value, controlling, by the controller, the driving unit to be stopped or to be operated reversely.

17. The method of claim 16, wherein upon determining that there is an occupant on a seat among the plurality of seats to be rotated or moved by reflecting an occupant's intention and there is no occupant on another neighboring seat among the plurality of seats, maintaining, by the controller, the load reference value as a predetermined value.

18. The method of claim 16, wherein upon determining that there is no occupant on a seat among the plurality of seats to be rotated or moved by reflecting an occupant's intention and there is no occupant on another neighboring seat among the plurality of seats, upwardly correcting, by the controller, the load reference value.

19. The method of claim 16, wherein upon determining that there is an occupant on a seat among the plurality of seats to be rotated or moved by reflecting an occupant's intention and there is an occupant on another neighboring seat among the plurality of seats, downwardly correcting, by the controller, the load reference value.

20. The method of claim 16,
wherein upon determining that a seat among the plurality of seats is rotated or moved toward another neighboring seat among the plurality of seats, downwardly correcting, by the controller, the driving speed of the driving unit and the load reference value, and
wherein upon determining that the seat is rotated or moved in a direction away from the another neighboring seat, upwardly correcting, by the controller, the driving speed of the driving unit and the load reference value.
